(19) United States
(12) Patent Application Publication
(10) Pub. No.: US 2013/0203898 A1
(43) Pub. Date: Aug. 8, 2013

(54) HYPERBRANCHED POLYMERS FOR MODIFYING THE TOUGHNESS OF CURED EPOXY RESIN SYSTEMS

(71) Applicants: Anna MUELLER-CRISTADORO, Waldems (DE); Jean-Francois Stumbe, Strasbourg (FR); Guenter Scherr, Ludwigshafen (DE); Michael Henningsen, Frankenthal (DE); Bernd Bruchmann, Freinsheim (DE); Monika Haberecht, Ludwigshafen (DE); Miran Yu, Ludwigshafen (DE); Chunhong Yin, Ludwigshafen (DE); Achim Kaffee, Lorsch (DE)

(72) Inventors: Anna MUELLER-CRISTADORO, Waldems (DE); Jean-Francois Stumbe, Strasbourg (FR); Guenter Scherr, Ludwigshafen (DE); Michael Henningsen, Frankenthal (DE); Bernd Bruchmann, Freinsheim (DE); Monika Haberecht, Ludwigshafen (DE); Miran Yu, Ludwigshafen (DE); Chunhong Yin, Ludwigshafen (DE); Achim Kaffee, Lorsch (DE)

(21) Appl. No.: 13/754,120

(22) Filed: Jan. 30, 2013

Related U.S. Application Data
(60) Provisional application No. 61/594,390, filed on Feb. 3, 2012.

(30) Foreign Application Priority Data
Feb. 3, 2012 (EP) 12153771.6

(51) Int. Cl. C08G 59/10

(52) U.S. Cl. CPC C08G 59/10
USPC 523/466; 528/98; 523/468

(57) ABSTRACT

The invention relates to a curable composition comprising one or more epoxy compounds, one or more amino hardeners, and an addition of one or more dendritic polymers selected from the group of the dendritic polyester polymers, where the dendritic polyester polymers can be produced through an Ax+By synthesis route.

The invention relates to a curable composition comprising one or more epoxy compounds, one or more amino hardeners and an addition of one or more dendritic polymers selected from the group consisting of the dendritic polyester polymers.

The invention further relates to the cured epoxy resin made of the curable composition, and also to moldings produced therefrom.

Epoxy resins are well known and, because of their properties of flexibility, adhesion, and chemicals resistance, are used as materials for surface coating, as adhesives, and for molding and lamination. In particular, epoxy resins are used for producing carbon-fiber-reinforced or glass-fiber-reinforced composite materials. Epoxy resins are also known in the electrical and machine-tool industry for use in casting, sealing, and encapsulation processes.

Epoxy materials are polyethers and can by way of example be produced by condensation of epichlorohydrin with a diol, for example with an aromatic diol such as bisphenol A. The epoxy resins are then cured by reaction with a hardener, typically a polyamine, as described in U.S. Pat. No. 4,447,586, U.S. Pat. No. 2,817,644, U.S. Pat. No. 3,629,181, DE 1006101, and U.S. Pat. No. 3,321,438.

Various possible curing methods are known. Starting from epoxy compounds having at least two epoxy groups it is possible by way of example to use an amino compound having two amino groups for curing by a polyaddition reaction (chain extension). Amino compounds having high reactivity are generally added only shortly before the intended time of curing. These are therefore what are known as two-component (2C) systems. As an alternative, materials known as latent hardeners can be used, an example being dicyandiamide; these are active only at high temperatures, and undesired premature curing is therefore avoided, and single-component (1C) systems can be produced.

The compositions of the invention, with the amino hardeners used, are of particular interest specifically in the automotive sector, where improved toughness of epoxy resins is desirable.

The object of the present invention is therefore to provide additions for compositions made of epoxy resins and of hardeners which improve the mechanical properties of the resultant cured epoxy resins, in particular their toughness.

Said object is achieved through a curable composition comprising one or more epoxy compounds, one or more amino hardeners for the curing of epoxy compounds, and an addition of one or more dendritic polymers selected from the group consisting of the dendritic polyester polymers.

The invention further provides a cured epoxy resin obtainable through the curing of the curable composition of the invention. It is preferable that the cured epoxy resin takes the form of a molding, and it is particularly preferable that it takes the form of a composite material, for example with glass fibers or with carbon fibers. The invention also provides fibers (for example glass fibers or carbon fibers) which have been preimpregnated with the curable composition of the invention (for example prepregs).

Hardeners of the invention for the curing of epoxy compounds are amino hardeners. Preferred amino hardeners are those selected from the group of 3,6-dioxa-1,8-octanediamine, 4,7,10-trioxa-1,13-tridecanediamine, 4,7-dioxa-1,10-decanediamine, 4,9-dioxa-1,12-docecanediamine polyetheramines based on triethylene glycol with average molecular weight 148. A difunctional primary polyetheramine produced by amination of a propylene-oxide-capped ethylene glycol with average molecular weight 176. A difunctional primary polyetheramine based on propylene oxide with average molecular weight 4000. A difunctional primary polyetheramine produced by amination of a propylene-oxide-capped polyethylene glycol with average molecular weight 2003. Aliphatic polyetheramine based on propylene-oxide-grafted polyethylene glycol with average molecular weight 900. Aliphatic polyetheramine based on propylene-oxide-grafted polyethylene glycol with average molecular weight 600. A difunctional primary polyetheramine produced by amination of a propylene-oxide-capped diethylene glycol with average molecular weight 220. Aliphatic polyetheramine based on a copolymer of poly(tetramethylene ether glycol) and polypropylene glycol with average molecular weight 1000. Aliphatic polyetheramine based on a copolymer of poly(tetramethylene ether glycol) and polypropylene glycol with significant content of secondary amines with average molecular weight 1900.

Aliphatic polyetheramine based on a copolymer of poly(tetramethylene ether glycol) and polypropylene glycol with average molecular weight 1400. Polyethertriamine based on a butylene-oxide-grafted at least trihydric alcohol with average molecular weight 400. Aliphatic polyetheramine produced by amination of butylene-oxide-capped alcohols with average molecular weight 219. Polyetheramine based on pentaerythritol and propylene oxide with average molecular weight 600.

Difunctional primary polyetheramine based on polypropylene glycol with average molecular weight 2000.

Difunctional primary polyetheramine based on polypropylene glycol with average molecular weight 400. Difunctional primary polyetheramine based on polypropylene glycol with average molecular weight 230.

A trifunctional primary polyetheramine produced by reaction of propylene oxide with trimethylolpropane followed by amination of the terminal OH groups with average molecular weight 403. A trifunctional primary polyetheramine produced by reaction of propylene oxide with glycerol followed by amination of the terminal OH groups with average molecular weight 5000 and a polyetheramine with average molecular weight 400 produced by amination of polyTHF having average molecular weight 250.

Other amines that can be used are those selected from the group of 1,12-diaminododecane, 1,10-diaminodecane, 1,2-diaminocyclohexane, 1,2-propanediamine, 1,3-bis(aminomethyl)cyclohexane, 1,3-propanediamine, 2,2′-oxybis(ethylamine), 4-ethyl-4-methylamino-1-octylamine, ethylenediamine, hexamethylenediamine, menthenediamine, xylylenediamine, n-aminoethylpiperazine, neopentanediamine, norbornanediamine, octanemethylenediamine, piperazine, 4,8-diaminotricyclo[5.2.1.0]decane, tolylenediamine, trimethylhexamethylenediamine, tetramethyl-4,4′-diaminodicyclohexylmethane, isophoronediamine, dicyandiamide, diethylenetriamine, triethylenetetramine, bis(p-aminocyclohexyl)methane, dimethyldicykan, diaminodiphenylmethane, diaminodiphenyl sulfone, 2,4-toluenediamine, 2,6-toluenediamine, 2,4-diamino-1-methylcyclohexane, 2,6-diamino-1-methylcyclohexane, 2,4-diamino-3,5-diethyltoluene, 2,6-diamino-3,5-diethyltoluene, and aminopropylimidazole, and also mixtures thereof. Particularly preferred amino hardeners for the curable composition of the invention are those selected from the group of diethylenetetramine and aminopropylimidazole.

It is also possible to use anhydride hardeners for the curing of epoxy compounds. Accordingly, this invention also provides curable compositions comprising one or more epoxy compounds, one or more amino hardeners, and one or more anhydride hardeners for the curing of epoxy compounds, and an addition of one or more dendritic polymers selected from the group consisting of the dendritic polyester polymers. Suitable anhydride hardeners are cyclic carboxylic anhydrides, for example succinic anhydride, maleic anhydride, phthalic anhydride, hexahydrophthalic anhydride, methylbicyclo[2.2.1]hept-5-ene-2,3-dicarboxylic anhydride, or trimellitic anhydride.

Among dendritic polymers are dendrimers and hyperbranched polymers. Hyperbranched polymers, like dendrimers, feature a highly branched structure and high functionality. Dendrimers are macromolecules having molecular uniformity and a highly symmetrical structure.

They can be produced, starting from a central molecule, through controlled, stepwise linkage of polyfunctional monomers to previously bonded monomers. The number of monomer end groups (and therefore the number of linkages) multiplies here by a factor of 2 or more with every linkage step, and the products are monodisperse polymers having a generational structure, with dendritic structures, which are ideally spherical, and the branches of which respectively comprise exactly the same number of monomer units. However, a factor that complicates the production of monodisperse dendrimers is that each linkage step requires introduction and, in turn, removal of protective groups, and intensive purification steps are required before starting each new growth stage, and for this reason dendrimers are usually produced only on a laboratory scale. The generational structure described is required in order to produce dendrimeric structures which are completely regular.

In contrast to this, hyperbranched polymers have both molecular and structural nonuniformity. They are obtained by using a non-generational structure. There is therefore also no need to isolate and purify intermediates. Hyperbranched polymers can be obtained through simple mixing of the components required for the structure and reaction of these in what is known as a one-pot reaction. Hyperbranched polymers can have dendrimeric substructures. However, they also have, alongside these, linear polymer chains and unequal polymer branches. Particularly suitable materials for synthesizing hyperbranched polymers are what are known as ABₓ monomers. These have two different functional groups A and B within one molecule, and these can react with one another intermolecularly to form a linkage. Each molecule here comprises only one functional group A, but two or more functional groups B. Reaction of said ABₓ monomers with one another produces uncrosslinked polymers having regularly arranged branching points. The polymers have almost exclusively B groups at the chain ends.

Hyperbranched polymers can also be produced by way of the Aₓ+B_{y} synthesis route. Aₓ and B_{y} here are two different monomers having the functional groups A and B, and the indices x and y are the number of the functional groups per monomer. Aₓ+B_{y} synthesis route, represented here by taking the example of A₂+B₃ synthesis route, reacts a difunctional monomer A₂ with a trifunctional monomer B₃. This first produces a 1:1 adduct made of A monomers and of B monomers having an average of one functional group A and two functional groups B, and this adduct can then likewise react to give a hyperbranched polymer. The hyperbranched polymers thus obtained again have predominantly B groups as end groups.

The degree of branching DB of the dendritic polymers is defined as

$$DB ( \% ) = \frac{T + Z}{T + Z + L} \times 100 ,$$

where T is the average number of terminally bonded monomer units, Z is the average number of monomer units forming branching points, and L is the average number of linearly bonded monomer units in the macromolecules of the respective substances.

The degree of branching thus defined distinguishes hyperbranched polymers from dendrimers. Dendrimers are polymers of which the degree of branching DB is from 99 to 100%. A dendrimer therefore has the maximum possible number of branching points, and this can only be achieved via a highly symmetrical structure. For the definition of “degree of branching”, see also Frey et al., Acta Polym. (1997), 48:30.

For the purposes of this invention, therefore, hyperbranched polymers are in essence uncrosslinked macromolecules which have structural nonuniformity. Their structure can be based on a central molecule, by analogy with dendrimers, but with non-uniform chain length of the branches. However, their structure can also be linear, having functional pendant branches, or else they can have linear and branched portions of the molecule. For the definition of dendrimers and of hyperbranched polymers, see also Flory, J. Am. Chem. Soc. (1952), 74:2718 and Frey et al., Chem. Eur. J. (2000), 6:2499. Further information relating to hyperbranched polymers and synthesis thereof can be found by way of example in J. M. S.—Rev. Macromol. Chem. Phys. (1997), C37:555-579 and the references cited therein.

Either dendrimers or hyperbranched polymers can be used as dendritic polymers in the invention. It is preferable to use hyperbranched polymers, where these differ from dendrimers, i.e. where these have both structural and molecular nonuniformity (and therefore do not have uniform molecular weight, but instead have a molecular weight distribution).

For the purposes of the present invention, “hyperbranched” means that the degree of branching (DB) is from 10 to 99%, preferably from 25 to 90%, and in particular from 30 to 80%.

“Dendrimers” in this context are dendritic polymers having a degree of branching (DB) of from >99 to 100%.

The hyperbranched polymers used in the invention are in essence uncrosslinked. For the purposes of the present invention, “in essence uncrosslinked” or “uncrosslinked” means that the degree of crosslinking is less than 15% by weight, preferably less than 10% by weight, where the degree of crosslinking is determined by way of the insoluble fraction of the polymer. By way of example, the insoluble fraction of the polymer is determined via extraction for 4 hours, in a Soxhlet apparatus, with a solvent identical with that used for the gel permeation chromatography process (GPC), i.e. preferably dimethylacetamide or hexafluoroisopropanol, depending on which solvent is more effective in dissolving the polymer, and weighing of the remaining residue after drying to constant weight.

The weight-average molar mass Mw of the dendritic polymers used in the invention is preferably at least 500 g/mol, e.g. from 500 to 200 000 g/mol, or preferably from 1000 to 100 000 g/mol, in particular from 1000 to 10 000 g/mol.

The dendritic polymers are dendritic polyester polymers based on di-(A₂), tri-(A₃) or polycarboxylic acid (Aₓ), and di-(B₂), tri-(B₃) or polyalcohols (B_{y}). The synthesis of compounds of this type is described by way of example in WO 05/118677.

Among the dicarboxylic acids (A₂) are by way of example aliphatic dicarboxylic acids, such as oxalic acid, malonic acid, succinic acid, glutaric acid, adipic acid, pimelic acid, suberic acid, azelaic acid, sebacic acid, undecane-α,ω-dicarboxylic acid, dodecane-α,ω-dicarboxylic acid, cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid, and cis- and trans-cyclopentane-1,3-dicarboxylic acid. It is moreover also possible to use aromatic dicarboxylic acids, for example phthalic acid, isophthalic acid, or terephthalic acid. It is also possible to use unsaturated dicarboxylic acids, such as maleic acid or fumaric acid.

The dicarboxylic acids mentioned can also have substitution with one or more radicals selected from

C₁-C₁₀-alkyl groups, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, trimethylpentyl, n-nonyl, or n-decyl,

C₃-C₁₂-cycloalkyl groups, such as cyclopropyl, cyclobutyl, cyclopentyl, cyclohexyl, cycloheptyl, cyclooctyl, cyclononyl, cyclodecyl, cycloundecyl, and cyclododecyl; preference is given to cyclopentyl, cyclohexyl, and cycloheptyl;

alkylene groups, such as methylene or ethylidene, or

C₆-C₁₄-aryl groups, such as phenyl, 1-naphthyl, 2-naphthyl, 1-anthryl, 2-anthryl, 9-anthryl, 1-phenanthryl, 2-phenanthryl, 3-phenanthryl, 4-phenanthryl, and 9-phenanthryl, preferably phenyl, 1-naphthyl, and 2-naphthyl, particularly preferably phenyl.

Examples of representatives that may be mentioned of substituted dicarboxylic acids are: 2-methylmalonic acid, 2-ethylmalonic acid, 2-phenylmalonic acid, 2-methylsuccinic acid, 2-ethylsuccinic acid, 2-phenylsuccinic acid, itaconic acid, and 3,3-dimethylglutaric acid.

It is also possible to use mixtures of two or more of the abovementioned dicarboxylic acids.

The dicarboxylic acids can be used either per se or in the form of derivatives.

Derivatives are preferably
the relevant anhydrides in monomeric or else polymeric form,
mono- or dialkyl esters, preferably mono- or di-C₁-C₄-alkyl esters, particularly preferably mono- or dimethyl esters or the corresponding mono- or diethyl esters,
and also mono- and divinyl esters, and also
mixed esters, preferably mixed esters having different
C₁-C₄-alkyl components, particularly preferably mixed methyl ethyl esters.

C₁-C₄-Alkyl is for the purposes of this specification methyl, ethyl, iso-propyl, n-propyl, n-butyl, iso-butyl, sec-butyl, and tert-butyl, preferably methyl, ethyl, and n-butyl, particularly preferably methyl and ethyl, and very particularly preferably methyl.

For the purposes of the present invention it is also possible to use a mixture of a dicarboxylic acid and of one or more of its derivatives. For the purposes of the present invention it is equally possible to use a mixture of a plurality of various derivatives of one or more dicarboxylic acids.

It is particularly preferable to use malonic acid, succinic acid, glutaric acid, adipic acid, 1,2-, 1,3-, or 1,4-cyclohexanedicarboxylic acid (hexahydrophthalic acids), phthalic acid, isophthalic acid, terephthalic acid, or mono- or dialkyl esters thereof.

Examples of tricarboxylic acids (A₃) or polycarboxylic acids (Aₓ) that can be reacted are aconitic acid, 1,3,5-cyclohexanetricarboxylic acid, 1,2,4-benzenetricarboxylic acid, 1,3,5-benzene-tricarboxylic acid, 1,2,4,5-benzenetetracarboxylic acid (pyromellitic acid), and also mellitic acid and low-molecular-weight polyacrylic acids.

Tricarboxylic acids or polycarboxylic acids (Aₓ) can be used in the reaction of the invention either per se or else in the form of derivatives.

Derivatives are preferably
the relevant anhydrides in monomeric or else polymeric form,
mono-, di- or trialkyl esters, preferably mono-, di-, or tri-C₁-C₄-alkyl esters, particularly preferably mono-, di-, or trimethyl esters or the corresponding mono-, di-, or triethyl esters,
and also mono-, di-, and trivinyl esters, and also
   mixed esters, preferably mixed esters having different C₁-C₄-alkyl components, particularly preferably mixed methyl ethyl esters.

For the purposes of the present invention it is also possible to use a mixture of a tri- or polycarboxylic acid and of one or more of its derivatives, an example being a mixture of pyromellitic acid and pyromellitic dianhydride. It is equally possible for the purposes of the present invention to use a mixture of a plurality of various derivatives of one or more tri- or polycarboxylic acids, an example being a mixture of 1,3,5-cyclohexanetricarboxylic acid and pyromellitic dianhydride.

Examples of diols (B₂) used according to the present invention are ethylene glycol, 1,2-propanediol, 1,3-propanediol, 1,2-butanediol, 1,3-butanediol, 1,4-butanediol, 2,3-butanediol, 1,2-pentanediol, 1,3-pentanediol, 1,4-pentanediol, 1,5-pentanediol, 2,3-pentanediol, 2,4-pentanediol, 1,2-hexanediol, 1,3-hexanediol, 1,4-hexanediol, 1,5-hexanediol, 1,6-hexanediol, 2,5-hexanediol, 1,2-heptanediol, 1,7-heptanediol, 1,8-octanediol, 1,2-octanediol, 1,9-nonanediol, 1,2-decanediol, 1,10-decanediol, 1,2-dodecanediol, 1,12-dodecanediol, 1,5-hexadiene-3,4-diol, 1,2- and 1,3-cyclopentanediols, 1,2-, 1,3-, and 1,4-cyclohexanediols, 1,1-, 1,2-, 1,3-, and 1,4-bis(hydroxymethyl)cyclohexanes, 1,1-, 1,2-, 1,3-, and 1,4-bis(hydroxyethyl)cyclohexanes, neopentyl glycol, (2)-methyl-2,4-pentanediol, 2,4-dimethyl-2,4-pentanediol, 2-ethyl-1,3-hexanediol, 2,5-dimethyl-2,5-hexanediol, 2,2,4-trimethyl-1,3-pentanediol, pinacol, diethylene glycol, triethylene glycol, dipropylene glycol, tripropylene glycol, polyethylene glycols HO(CH₂CH₂O)ₙ—H or polypropylene glycols HO(CH[CH₃]CH₂O)ₙ—H, where n is a whole number and n is ≧4, polyethylene polypropylene glycols, where the sequence of the ethylene oxide units or propylene oxide units can take the form of blocks or can be random, polytetramethylene glycols, preferably up to a molar mass of up to 5000 g/mol, poly-1,3-propanediols, preferably with molar mass up to 5000 g/mol, polycaprolactones, or a mixture of two or more representatives of the preceding compounds. One, or else both, hydroxy groups in the abovementioned diols can be replaced by SH groups. Diols whose use is preferred are ethylene glycol, 1,2-propanediol, 1,3-propanediol, 1,4-butanediol, 1,5-pentanediol, 1,6-hexanediol, 1,8-octanediol, 1,2-, 1,3-, and 1,4-cyclohexanediol, 1,3- and 1,4-bis(hydroxymethyl)cyclohexane, and also diethylene glycol, triethylene glycol, dipropylene glycol, and tripropylene glycol.

The dihydric alcohols B₂ can optionally also comprise further functionalities, e.g. carbonyl, carboxy, alkoxycarbonyl, or sulfonyl, examples being dimethylolpropionic acid or dimethylolbutyric acid, and also C₁-C₄-alkyl esters thereof, but it is preferable that the alcohols B₂ have no further functionalities.

At least trihydric alcohols (B_{y}) comprise glycerol, trimethylolmethane, trimethylolethane, trimethylolpropane, 1,2,4-butanetriol, tris(hydroxymethyl)amine, tris(hydroxyethyl)amine, tris(hydroxypropyl)amine, pentaerythritol, diglycerol, triglycerol, or higher condensates of glycerol, di(trimethylolpropane), di(pentaerythritol), trishydroxymethyl isocyanurate, tris(hydroxyethyl) isocyanurate (THEIC), tris(hydroxypropyl) isocyanurate, inositoles or sugars, e.g. glucose, fructose, or sucrose, sugar alcohols e.g. sorbitol, mannitol, threitol, erythritol, adonitol (ribitol), arabitol (lyxitol), xylitol, dulcitol (galactitol), maltitol, isomalt, and at least trihydric polyetherols based on at least trihydric alcohols and ethylene oxide, propylene oxide, and/or butylene oxide.

Particular preference is given here to glycerol, diglycerol, triglycerol, trimethylolethane, trimethylolpropane, 1,2,4-butanetriol, pentaerythritol, tris(hydroxyethyl) isocyanurate, and also to polyetherols of these based on ethylene oxide and/or propylene oxide.

WO 07/125,029, WO 05/037893, WO 03/093343, and WO 04/020503 describe other highly branched polymers which can be used in an embodiment of the invention.

Pages 10 to 17 of WO-A 2005/118677 provide a detailed description of the production of the respective polyesters used.

Pages 29 to 35 in WO 07/125,029 provide a detailed description of the production of the respective polyesters used.

Pages 11 to 17 in WO 05/037893 provide a detailed description of the production of the respective polyesters used.

There have been various reports of the addition of hyperbranched polymers for modifying mechanical properties of epoxy systems cured by amino hardeners or by UV radiation (Ratna et al., J Mater Sci (2003) 38:147-154; Ratna et al., Polymer (2001) 42:8833-8839; Ratna et al., Polym. Eng Sci (2001) 41:1815-1822; Sangermano et al., Polym Int (2005) 54:917-921; Boogh et al., Proceedings ICCM-12 Conference, Paris, France (1999); Cicala et al., Poly Eng Sci (2009) 49:577-584). However, the systems studied in all of the above work are based on curing-process reaction mechanisms other than those of the epoxy systems of the invention using anionically curing catalysts for the curing of the epoxy compounds.

Preferred compositions are composed of at least 30% by weight, preferably at least 50% by weight, very particularly preferably at least 70% by weight, of epoxy compounds (ignoring any solvents used concomitantly).

The content of the dendritic polymer is preferably no higher than 15 parts by weight, in particular no higher than 12 parts by weight, based on 100 parts by weight of epoxy compound.

Epoxy compounds according to this invention have from 2 to 10, preferably from 2 to 6, very particularly preferably from 2 to 4, and in particular 2, epoxy groups. The epoxy groups are in particular glycidyl ether groups, as produced in the reaction of alcohol groups with epichlorohydrin. The epoxy compounds can be low-molecular-weight compounds, which generally have an average molar mass (Mw) smaller than 1000 g/mol, or relatively high-molecular-weight compounds (oligomers or polymers). The degree of oligomerization of these oligomeric or polymeric epoxy compounds is preferably from 2 to 25, particularly preferably from 2 to 10, monomer units. They can be aliphatic or cycloaliphatic compounds, or compounds having aromatic groups. In particular, the epoxy compounds are compounds having two aromatic or aliphatic 6-membered rings, or are oligomers thereof. Epoxy compounds important in industry are those obtainable through reaction of epichlorohydrin with compounds which have at least two reactive H atoms, in particular with polyols. Particularly important compounds are epoxy compounds obtainable through reaction of epichlorohydrin with compounds which comprise at least two, preferably two, hydroxy groups, and two aromatic or aliphatic 6-membered rings. Compounds of this type that may be mentioned are in particular bisphenol A and bisphenol F, and also hydrogenated bisphenol A and bisphenol F. An epoxy compound usually used according to this invention is bisphenol A diglycidyl ether (DGEBA). It is also possible to use reaction products of epichlorohydrin with other phenols, e.g. with cresols, or with phenol-aldehyde adducts, such as phenol-formaldehyde resins, in particular novolaks. Other suitable compounds are epoxy compounds which do not derive from epichlorohydrin. Examples of those that can be used are epoxy compounds which obtain the epoxy groups through reaction with glycidyl (meth)acrylate.

The curable composition of the invention can comprise further constituents in addition to the epoxy compound, the amino hardener, and/or the anhydride hardener, and the dendritic polymer selected from the group consisting of the dendritic polyester polymers. Examples of these additional constituents are phenolic resins, anhydride hardeners, fillers, and pigments. The composition of the invention can also comprise solvents. It is optionally possible to use organic solvents in order to adjust viscosities as desired. It is preferable that the composition comprises at most subordinate amounts of solvents, for example amounts smaller than 5 parts by weight for every 100 parts by weight of epoxy compound.

The curable composition of the invention is suitable for 1 C systems or else as storable component for 2 C systems. In the case of 2 C systems, the components are brought in contact with one another only shortly before use, and the resultant mixture is then no longer stable in storage because the crosslinking reaction or curing process begins and causes a viscosity rise. 1 C systems already comprise all of the necessary constituents, and are stable in storage.

The composition with amino hardeners for the curing of the epoxy compound is preferably liquid at usage temperatures of from 10 to 100° C., particularly preferably from 20 to 40° C. The increase in the viscosity of the entire composition at temperatures up to 50° C. over a period of 10 hours, in particular of 100 hours (from addition of the latent catalyst) is smaller than 20%, particularly preferably smaller than 10%, very particularly preferably smaller than 5%, in particular smaller than 2%, based on the viscosity of the composition without the latent catalyst at 21° C., at 1 bar.

The curing process can take place at standard pressure and at temperatures below 250° C., in particular at temperatures below 200° C., preferably at temperatures below 175° C., in particular in the temperature range from 40 to 175° C. The curing process can also optionally be followed by conditioning of the material. The conditioning process preferably takes place in the temperature range from 10° C. below the T_{g} of the material to 60° C. above the T_{g} of the material. The material is preferably conditioned for at least one hour.

The compositions of the invention are suitable as coating compositions or impregnating compositions, as adhesive, for producing moldings and composite materials, or as casting compositions for the embedding, binding, or strengthening of moldings. Examples that may be mentioned in coating compositions are lacquers. In particular, the compositions of the invention can be used to obtain scratch-resistant protective lacquers on any desired substrates, e.g. made of metal, plastic, or of timber materials. The compositions are also suitable as insulating coatings in electronic applications, e.g. as insulating coating for wires and cables. Mention may also be made of the use for producing photoresists. They are in particular also suitable as repair coating in applications including, for example, the renovation of pipes without dismantling of the pipes (cure in place pipe (CIPP) rehabilitation). They are also suitable for sealing floorcoverings.

In composite materials (composites) there are different materials bonded to one another, for example plastics and reinforcing materials (such as glass fibers or carbon fibers).

Production processes that may be mentioned for composite materials are the curing of preimpregnated fibers or fiber webs (e.g. prepregs) after storage, and also extrusion, pultrusion, winding, and resin transfer molding (RTM), and resin infusion technologies (RI).

The compositions are suitable by way of example for producing preimpregnated fibers, e.g. prepregs, and further processing of these to give composite materials. In particular, the fibers can be saturated with the composition of the invention and then cured at a relatively high temperature. No, or only slight, curing takes place during the saturation process or any subsequent storage.

The inventive addition of dendritic polymers selected from the group consisting of the dendritic polyester polymers in epoxy compositions using amino hardeners for the curing of the epoxy compound brings about an improvement in the toughness of the cured epoxy resin that can be produced therefrom, when comparison is made with corresponding compositions without said addition. In particular, the cured epoxy resins have improved cracking resistance and/or improved fracture toughness (K_{IC} value). The glass transition temperature (T_{g}) is reduced only slightly here. The inventive addition of dendritic polymers selected from the group consisting of the dendritic polyester polymers does not reduce the modulus of elasticity, or reduces it only slightly. Moldings with these improved properties are in particular of interest for components, in particular composite materials, which are subject to stringent mechanical requirements.

Cracking resistance or fracture toughness K_{IC} is a measure of the resistance of a material to propagation of cracks. It can be determined in accordance with the standard ISO 15386.

Modulus of elasticity is a measure of the resistance of a material to deformation. Materials with relatively high modulus of elasticity permit the production of components and workpieces with relatively high stiffness for a given geometry of the component. It can be determined in accordance with Saxena and Hudak, Int J Fracture (1978) 14(5), or in accordance with the standards DIN EN ISO 527, DIN EN 20527, DIN 53455/53457, DIN EN 61, or ASTM D638 (tensile test), or in accordance with the standards DIN EN ISO 178, DIN EN 20178, DIN 53452/53457, DIN EN 63, or ASTM D790 (flexural test).

The glass transition temperature T_{g} is the temperature at which a plastic begins to soften. It can be determined by means of dynamic differential calorimetry (DSC, Differential Scanning calorimetry) in accordance with the standard DIN 53765. It can also be determined by means of dynamic-mechanical analysis (DMA). Here, a rectangular test specimen is subjected to torsion with an imposed frequency and prescribed deformation (DIN EN ISO 6721), the temperature is increased at a defined rate, and storage modulus and loss modulus are recorded at fixed time intervals. The former modulus represents the stiffness of a viscoelastic material. The latter modulus is proportional to the energy dissipated within the material. The phase shift between the dynamic stress and the dynamic deformation is characterized by the phase angle. The glass transition temperature can be determined by various methods, for example as maximum of the tan-□curve, as maximum of the loss modulus, or by means of a tangent method applied to the storage modulus.

The non-limiting examples below provide further explanation of the invention.

### EXAMPLE 1

### Synthesis of a Polyester from Glycerol and Adipic Acid

1216 g of glycerol and 1754 g of adipic acid are used as initial charge in a 4 L four-necked flask equipped with stirrer, internal thermometer, gas-inlet tube for nitrogen, reflux condenser, and vacuum connection with cold trap. 0.68 g of dibutyltin dilaurate is added to the mixture under nitrogen flowing at low flow rate, and an oil bath is used to heat the mixture to an internal temperature of 145° C.

After one hour, the internal temperature is increased to 185° C., and the water produced is removed. After removal of 343 g of water, 337 g of glycerol are added, and after one hour at 185° C. a reduced pressure of 400 mbar is applied. The reaction mixture is kept at said pressure for 4 hours, at said temperature. The material is cooled to room temperature and analyzed:

Acid number in accordance with DIN 53240, Part 2: 7 mg KOH/g

OH number in accordance with DIN 53240, Part 2: 495 mg KOH/g

The polyester was analyzed by gel permeation chromatography, using a refractometer as detector.

Dimethylacetamide is used as mobile phase, and polymethyl methacrylate (PMMA) is used as standard for determination of molar mass.

Mn: 1241 g/mol

Mw: 4334 g/mol

(This synthesis is described in more detail in the Patent WO07125029, being similar to examples 1.1 to 1.7)

### EXAMPLE 2

### Synthesis of a Polyester from Glycerol and Succinic Acid

1216 g of glycerol and 1417 g of succinic acid are used as initial charge in a 4 L four-necked flask equipped with stirrer, internal thermometer, gas-inlet tube for nitrogen, reflux condenser, and vacuum connection with cold trap. 0.8 g of dibutyltin dilaurate is added to the mixture under nitrogen flowing at low flow rate, and an oil bath is used to heat the mixture to an internal temperature of 145° C.

After one hour, the internal temperature is increased to 185° C., and the water produced is removed. After removal of 335 g of water, 270 g of glycerol are added, and after one hour at 185° C. a reduced pressure of 400 mbar is applied. The reaction mixture is kept at said pressure for 4 hours, at said temperature. The material is cooled to room temperature and analyzed:

Acid number in accordance with DIN 53240, Part 2: 15 mg KOH/g

OH number in accordance with DIN 53240, Part 2: 543 mg KOH/g

The polyester is analyzed by gel permeation chromatography, using a refractometer as detector.

Dimethylacetamide is used as mobile phase, and polymethyl methacrylate (PMMA) is used as standard for determination of molar mass.

Mn: 1724 g/mol

Mw: 4654 g/mol

(This synthesis is described in more detail in the Patent WO07125029, being similar to examples 1.8 and 1.9)

### EXAMPLE 3

### Synthesis of a Polyester from Trimethylolpropane 5×PO and C18-Alkenylsuccinic Acid

1740 g (5.00 mol, M=348 g/mol) of C₁₋₈-alkenylsuccinic ester anhydride (Pentasize from Trigon) and 591 g of trimethylolpropane, randomly propoxylated with 5×PO (1.37 mol, M 430 g/mol) are used as initial charge in a 4 L four-necked flask equipped with stirrer, internal thermometer, reflux condenser, and vacuum connection with cold trap. 0.2 g of dibutyltin dilaurate is added to the mixture under nitrogen flowing at low flow rate, and an oil bath is used to heat the mixture to an internal temperature of 185° C. A reduced pressure of 10 mbar is then slowly applied, and the reaction mixture is stirred for 20 hours. The water produced is removed by distillation. The material is cooled to room temperature and analyzed:

Acid number in accordance with DIN 53240, Part 2: 108 mg KOH/g

The polyester is analyzed by gel permeation chromatography, using a refractometer as detector.

Tetrahydrofuran is used as mobile phase, and polymethyl methacrylate (PMMA) is used as standard for determination of molar mass.

Mn: 930 g/mol

Mw: 6100 g/mol

(This synthesis is described in more detail in the patent WO05037893.)

### EXAMPLE 4

### Synthesis of a Polyester from Trimethylolpropane 5×PO and Phthalic Anhydride

138 g of phthalic anhydride and 401 g of trimethylolpropane, randomly propoxylated with 5×PO, are used as initial charge in a 1 L four-necked flask equipped with stirrer, internal thermometer, and reflux condenser. The reaction mixture is heated to 160° C. and once a homogeneous mixture has been obtained 0.2 g of titanium tetrabutoxide is added, and the reaction mixture is heated to 180° C. The reaction mixture is stirred for 24 hours, and water is removed as distillate. The material is cooled to room temperature and analyzed:

Acid number in accordance with DIN 53240, Part 2: 44 mg KOH/g

OH number in accordance with DIN 53240, Part 2: 130 mg KOH/g

The polyester is analyzed by gel permeation chromatography, using a refractometer as detector.

Tetrahydrofuran is used as mobile phase, and polymethyl methacrylate (PMMA) is used as standard for determination of molar mass.

Mn: 490 g/mol

Mw: 1330 g/mol

### EXAMPLE 5

### Synthesis of a Polyester from Trimethylolpropane 15×PO and Phthalic Anhydride

62 g of phthalic anhydride and 438 g of trimethylolpropane, randomly propoxylated with 15×PO are used as initial charge in a 1 L four-necked flask equipped with stirrer, internal thermometer, and reflux condenser. The reaction mixture is heated to 160° C. and once a homogeneous mixture has been obtained 0.15 g of titanium tetrabutoxide is added, and the reaction mixture is heated to 180° C. The reaction mixture is stirred for 24 hours, and water is removed as distillate. The material is cooled to room temperature and analyzed:

Acid number in accordance with DIN 53240, Part 2: 33 mg KOH/g

OH number in accordance with DIN 53240, Part 2: 80 mg KOH/g

The polyester is analyzed by gel permeation chromatography, using a refractometer as detector.

Tetrahydrofuran is used as mobile phase, and polymethyl methacrylate (PMMA) is used as standard for determination of molar mass.

Mn: 1080 g/mol

Mw: 1840 g/mol

### EXAMPLE 6

### Synthesis of a Polyester from Trimethylolpropane, Sebacic Acid, and Phthalic Anhydride

121 g of phthalic anhydride, 163 g of sebacic acid, and 217 g of trimethylolpropane are used as initial charge in a 1 L four-necked flask equipped with stirrer, internal thermometer, gas-inlet tube for nitrogen, reflux condenser, and vacuum connection with cold trap. The reaction mixture is heated to 160° C. and once a homogeneous mixture has been obtained 0.15 g of titanium tetrabutoxide is added, and the reaction mixture is heated to 180° C. The reaction mixture is stirred for 3 hours, and water is removed as distillate. The material is cooled to room temperature and analyzed:

Acid number in accordance with DIN 53240, Part 2: 64 mg KOH/g

OH number in accordance with DIN 53240, Part 2: 230 mg KOH/g

The polyester is analyzed by gel permeation chromatography, using a refractometer as detector.

Tetrahydrofuran is used as mobile phase, and polymethyl methacrylate (PMMA) is used as standard for determination of molar mass.

Mn: 570 g/mol

Mw: 2700 g/mol

### EXAMPLES 7

### Effect of Dendritic Polymers on the Mechanical Properties of Amine-Cured Epoxy Resins

In each case, 100 g of a bisphenol A-type epoxy resin (DGEBA, Epilox A 18-00 from LEUNA-Harze GmbH, viscosity 8000-10000 mPAs) and 11 g of a 1:2 mixture of diethylenetetramine and aminopropylimidazole were mixed with an addition of in each case 2.5 g of the dendritic polymers described in examples 1 to 6. A corresponding mixture without addition of any dendritic polymer served as reference. The curable compositions thus obtained were cured with staged increase of temperature to 50° C. for two hours, 90° C. for three hours, and finally 150° C. for a further 4 h.

The mechanical properties of the resultant cured epoxy resins were determined in accordance with ISO 178:2010 (flexural test) and ISO 527-2:1993 (tensile test). For this, the following were produced by milling: in each case 10 test specimens (dumbbell shape 1A) and 9 test specimens measuring 80×10×4 mm in C109. Glass transition temperature (T_{g}) was determined by the DSC method (Differential Scanning calorimetry, DSC 204 F1 from Netzsch) in accordance with the specification in DIN 53 765.

Table 1 collates the results of the tests.

TABLE 1
Mechanical properties of amine-cured epoxy resins with and
without addition of dendritic polymers

| | | Modulus of | | | |
|---|---|---|---|---|---|
| | | elasticity | Flexural | Tensile | Tensile |
| Additive | T_{g} (° C.) | (MPa) | (E′fM) | M % | E-t-M |
| — | 141.0 | 3010 | 5.7 | 5.26 | 2882 |
| PS1 | 134.5 | 3031 | 4.6 | 5.4 | 2928 |
| PS2 | 134 | 3126 | 6.1 | 5.5 | 2975 |
| PS3 | 140 | 2912 | 5.2 | 5.29 | 2815 |
| PS4 | 134 | 3056 | 5.05 | 4.89 | 2955 |
| PS5 | 134 | 3063 | 4.6 | 6.23 | 2930 |
| PS6 | 139 | 3013 | 5.16 | 5.92 | 2897 |

### EXAMPLES 8

### Effect of Dendritic Polymers on the Mechanical Properties of Amine-Cured Epoxy Resins

In each case, 100 g of a bisphenol A-type epoxy resin (DGEBA, Epilox A 18-00 from LEUNA-Harze GmbH, viscosity 8000-10000 mPAs) and 13.5 g of a 1:2 mixture of diethylenetetramine and aminopropylimidazole were mixed with an addition of in each case 2.5 g of the dendritic polymers described in examples 1 and 2. A corresponding mixture without addition of any dendritic polymer served as reference. The curable compositions thus obtained were cured with staged increase of temperature to 50° C. for two hours, 90° C. for three hours, and finally 150° C. for a further 4 h.

The mechanical properties of the resultant cured epoxy resins were determined in accordance with ISO 178:2010 (flexural test) and ISO 527-2:1993 (tensile test). For this, the following were produced by milling: in each case 10 test specimens (dumbbell shape 1A) and 9 test specimens measuring 80×10×4 mm in C109. Glass transition temperature (T_{g}) was determined by the DSC method (Differential Scanning calorimetry, DSC 204 F1 from Netzsch) in accordance with the specification in DIN 53 765.

Table 2 collates the results of the tests.

TABLE 2
Mechanical properties of amine-cured epoxy resins
with and without addition of dendritic polymers

| | | Modulus of | | | | |
|---|---|---|---|---|---|---|
| | T_{g} | elasticity | Flexural | Tensile | Tensile | K_{IC} |
| Additive | (° C.) | (MPa) | (E′fM) | M % | E-t-M | MPa m_{1/2} |
| — | 130.0 | 3122 | 6.1 | 7.7 | 3005 | 1.15 |
| PS1 | 125.0 | 3323 | 5.9 | 7.1 | 3182 | 1.1 |
| PS2 | 128 | 3264 | 6.1 | 6.2 | 3126 | 1.27 |

1. A curable composition comprising one or more epoxy compounds, one or more amino hardeners for the curing of epoxy compounds, and an addition of one or more dendritic polymers selected from the group of the dendritic polyester polymers.

2. The curable composition according to claim 1, comprising one or more epoxy compounds, one or more amino hardeners for the curing of epoxy compounds, and an addition of one or more dendritic polymers selected from the group of the dendritic polyester polymers, where the dendritic polyester polymers can be produced through an Ax+By synthesis route.

3. The curable composition according to claim 1 or 2, where the amino hardener is one selected from the group of diethylenetetramine and aminopropylimidazole.

4. The curable composition according to any of claims 1 to 3, where the dendritic polymer is a dendritic polyester polymer.

5. The curable composition according to claim 4, where the dendritic polyester polymer is a polyol having terminal alcohol groups and/or carboxy groups.

6. A cured epoxy resin that can be produced through curing of the curable composition according to any of claims 1 to 5.

7. A molding made of the cured epoxy resin according to claim 6.

8. A composite material comprising glass fibers or carbon fibers and the cured epoxy resin according to claim 7.

9. A fiber which has been preimpregnated with the curable composition according to any of claims 1 to 5.
